(19) United States
(12) Patent Application Publication
(10) Pub. No.: US 2008/0077517 A1
(43) Pub. Date: Mar. 27, 2008

(54) Reputation, Information & Communication Management

(76) Inventor: Robert Grove Sappington, Sammamish, WA (US)

Correspondence Address: Robert Sappington, 20215 NE 39th Street, Sammamish, WA, 98074, US

(21) Appl. No.: 11/858,883

(22) Filed: Sep. 20, 2007

Related U.S. Application Data
(60) Provisional application No. 60/846,669, filed on Sep. 22, 2006.

(51) Int. Cl. G06Q 40/00; G06F 15/16; G06Q 10/00

(52) U.S. Cl. 705/35; 705/1; 709/204; 709/206

(57) ABSTRACT

Methods and a system are described for communication and information management. The methods create and manage multi-factor multi-level reputations, detect and manage fraudulent and manipulative behavior, permit management of information and communications, quantify qualitative information, and derive derivative uses (such as prediction and targeted advertising) from multi-factor reputations, data and behavior. The system described is hierarchical with progressive information and communication management capabilities as reputations increase. The structure of the system is designed to assist reputation calculations.

### CROSS-REFERENCE TO RELATED APPLICATIONS

This patent application claims the benefit of priority to U.S. Provisional Patent Application Ser. No. 60/846,669 filed 22 Sep. 2006 and entitled Reputation And Communication Management In Social Networks, which application is hereby incorporated by reference.

### BACKGROUND

The current state of the art varies by communication channel: voice, email, and Internet. Voice communication over digital, analog, and analog to digital networks does not currently permit analysis, filtering, and sorting of information or communications by value to the recipient.

Communication through email currently enables filtering of some unwanted content through the use of spam filters. The remaining email content may be sorted automatically by date, recipient, and sender assigned importance. Email communication currently does permit users to sort messages by keyword content screens and sender email address. Email communication currently does not enable the user to automatically screen or sort messages by value to the recipient.

Internet communication involves many different types of forums. For brevity, two forums are described here, social networks and web pages. Social networks, e.g. MySpace, Facebook, Friendster, LinkedIn, etc., utilize a number of electronic communication channels, including: web pages, message boards, chat rooms, instant messaging, and multimedia. These networks allow users to rate the quality of content by completing a feedback form. Content rated highly by users is then listed by quality score in “top 10” listing formats. No sorting or searching by multifactor user values is possible. The web site www.slashdot.org collects feedback from readers of content posted on the SlashDot web page and enables a subsegment of users to act as moderators that assign value to content. Viewers of the website's content may then screen messages based upon content ratings. Users develop a single factor “karma” rating that reflects the ratings of their content contributions, moderation efforts, and story submissions for the site. Good karma ratings allow users to moderate more content. The web site uses statistical analysis to judge fairness of moderator ratings. Slashdot's protocol for content valuation is limited to moderator feedback on a quality scale. User “karma” is limited to discrete scores on content quality, moderator quality, and story submission.

The current state of the art does not enable communication receivers to manage communications or information by recipient defined preferences for content, beyond a generic quality rating, or senders' importance specification. The current state also does not enable senders to screen and sort recipients on multiple dimensions. The lack of specificity in the current state does not permit secondary and metadata products and valuation to be created.

### SUMMARY

This invention improves upon communication by electronic means because it improves searching and filtering of communications through any digital or analog to digital communication channel. In addition the invention enables secondary benefits from communication, digital content, and persons using computer and/or telephone networks by describing value to the users and information and using algorithms to identify relationships in information and users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a graphical depiction of a hierarchical progressive capability network.

FIG. 2 is a diagram of example relationships between multi-factor reputation components.

FIG. 3 is a generic information flow diagram of multi-factor reputation development and fraud management.

FIG. 4 is an example of a multi-factor quality metric.

FIG. 5 is an example of a multi-factor reputation component.

### DETAILED DESCRIPTION

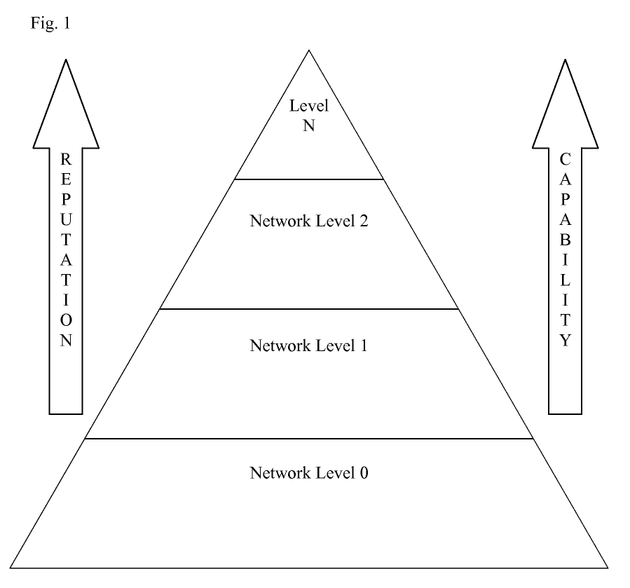

The invention employs user reputation and preferences to manage communication (one-to-many, many to many and one-to-one) in electronic communications, such as (but not limited to) voice, email, and Internet. User is defined broadly as a living being, entity, object, information, algorithm or other item that may affect or interact with other users. For brevity and by way of example, this description will focus on people interacting in social networks through the Internet and email, but a person skilled in the art will realize the same approach works with other communication channels and user types. A user's reputation evolves from a number of inputs: content submissions and usage, user feedback on other user's content, other user's feedback on a user's content, external data and automated behavior based analysis. As a user's reputation improves the user will gain permission to access progressively more exclusive forums in the social network and manage one-to-one (or one to many, or many to many) communications, e.g. e-mail, by the multi-factor reputation of the sending user contacting the receiving user and the value of the message to the receiving user, see FIG. 1.

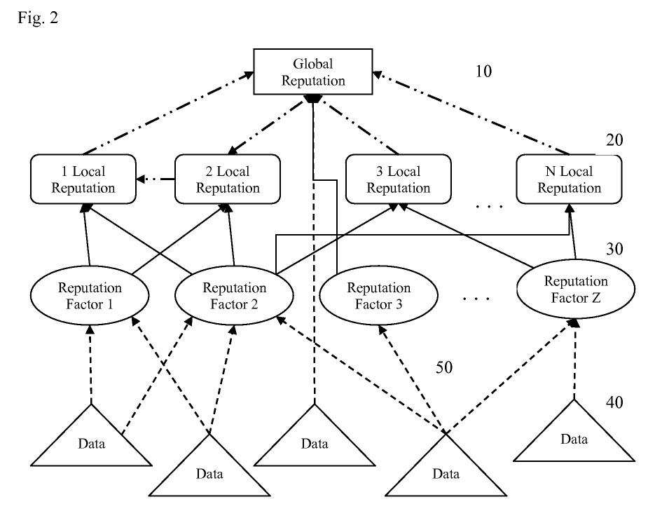

FIG. 2 portrays an example of one type of structure and relationships for a multi-factor reputation. Each user in the system has a global reputation. A global reputation 10 is composed of two or more local reputations 20, reputation factors 30 or data points 40 or any combination of these. Local reputations are specific in some manner, e.g. by use, by location, by item, etc., and may be composed of reputation factors and data points. Local reputations may also be influenced by a user's global reputation. The arrows 50 in the diagram represent mathematical relationships between the components. Someone skilled in the art will note that many relationship patterns are possible with varying numbers of relationship component sets.

In one embodiment, reputation is a multifactor scoring system that incorporates standard factors as well as user created factors to rank a user by percentile of the total network population. Ratings on various factors assess the quality of content a user and other users submit to the social network. Content quality derives part of a user's reputation score in aggregate and on subfactors, such as but not limited to creativity, leadership, initiative, integrity, communication, attractiveness, objectivity, persuasiveness and others. The examples listed here are for illustrative purposes and do not represent the entire range of factors that this invention covers.

An illustrative example is the creativity factor. A user, Susan, uploads an original photograph to the original artwork web site of the social network. A first implementation may simply survey other users viewing Susan's photograph submission to rate her creativity. Results of this direct survey would be applied to Susan's creativity reputation factor. The creativity factor could then be aggregated into an overall reputation value along with factors.

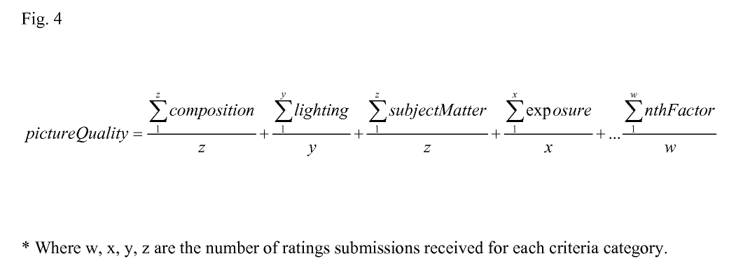

A second implementation indirectly and automatically generates values for the creativity reputation factor. This is a more powerful approach because reputation values may be developed automatically while users are doing other things. In this implementation, one or more other users provide feedback on Susan's submission by responding to survey questions that grade Susan's photograph by various criteria of artistic merit, such as composition, lighting, subject matter, exposure, etc. These artistic criteria are averaged over the number of feedback submissions received then aggregated into a quality metric for the photograph, which in this instance is by a simple sum of the form in FIG. 4.

For this example, assume that the only rating criteria are composition, lighting, subject matter and exposure. Criteria ratings submitted by users may be weighted when averaging the responses to emphasize the rating submissions from users with high aggregate reputation values or high relevant reputation factors. Thus, a user rating from a person with a high creativity factor value would be multiplied by a factor greater than that of a user with a low creativity rating. To illustrate, David has a creativity rating of 5 while Mary has a creativity rating of 2. David's rating of Susan's photograph is 2½ times more important than Mary's rating. Those skilled in the art will realize there a wide variety of ratings schemes possible.

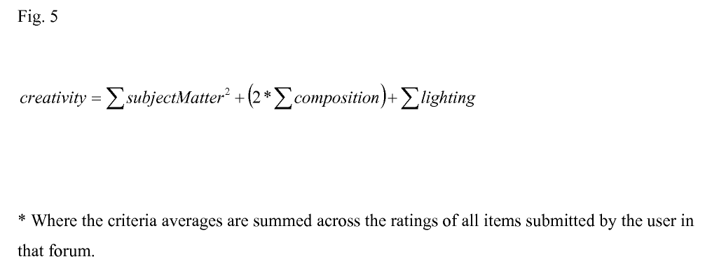

The venue in which Susan submitted her photograph requires users to submit only original artwork. Thus, the ratings that Susan receives in this venue may influence her creativity reputation factor. For example, Susan receives simple average ratings for the picture criteria in the following manner: composition=4, lighting=3, subject matter=3, and exposure=5. The example creativity function defined for this venue is as follows in FIG. 5.

A subset of criteria is used to calculate a creativity reputation factor in a non-linear manner. Only a portion of the rating criteria were deemed relevant to the criteria factor and incorporated into the calculation. Susan has only submitted one picture; therefore her creativity rating will be 20. The probability of achieving this score given the statistical distribution of ratings for the creativity factor will be calculated. Assume the population of scores indicates that Susan's score places her creativity score in the 15^{th} percentile. This creativity factor is incorporated into her global and local reputations by, for example but not limited to, a summation with other reputation factors. The local reputation calculation emphasizes creativity because the local venue (original photographic images) is art based. Thus, Susan has improved her standing in the local network from the bottom percentile (with no rating) to a higher level, say the 10^{th} percentile. In the progressive hierarchical structure of the system, she will now have the ability to filter out submissions from users with lower reputations within this venue.

Note that, as conceived in Equation 2 above, a significant volume bias exists in the creativity algorithm. Users continually submitting low quality photographs would steadily build their creativity ranking to the detriment of higher quality but lower volume submitters. Further refinements account for this volume effect in a number of different ways. For example, the creativity function may sample only the most recent 30 submissions by a user. In this approach, Susan's single rating does not carry the same weight as someone with more evidence to support their factor rating, but Susan will not be swamped by high volume low quality users. Alternatively, an average of criteria or an average with a penalty factor for fewer than the required minimum number of submissions may be used. Those skilled in the art will realize any mathematical method may be used to create reputation and factor calculators. Factors and rating criteria may or may not be venue specific.

Surveys are not the only methodology for determining user reaction to content. Tonal analysis of text comments made by other users is an alternative. For example, how many times do positive words like “good” or “great” appear in the comment versus negative words like “bad.” Other inputs, such as (but not limited to) time spent viewing content, number of times viewing content, or whether the content was forwarded or saved by the reviewer, may be used alone or in conjunction with other methods.

Data types and collection methodologies will vary by reputation factor. For example, the initiative reputation factor may utilize data points like the frequency that a user initiates new discussions in a message board or starts new forums in a social network combined with the number of other users engaging in the new discussions or forums. This factor may be combined with but not limited to other reputation factors such as communication, objectivity, persuasiveness, and creativity to form a derived reputation factor like leadership.

Additional automated behavioral algorithms analyze user interaction to calculate other reputation factors. Several examples illustrate this point. In one example, how close a user's feedback on other user's content is to a measure of success, such as but not limited to measures of central tendency, probability, or sales volume, may be used to calculate the predictive power of a user's feedback, i.e. a trendsetter factor. Users with high trendsetter reputation factors may be monitored to predict things. In a similar manner, users with high trendsetter factors and other characteristics, such as but not limited to types of content viewed may be classified as having the psychographic profile of early adopters. These individuals may then be shown targeted advertising to assess reaction to new products. The targeting algorithm using, in part or whole, the user's multi-factor reputation.

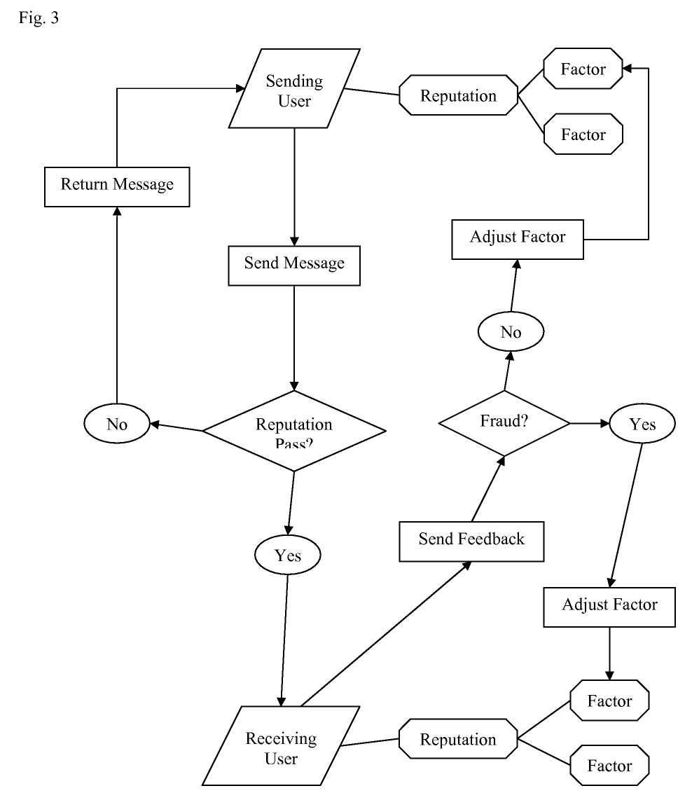

Implicit in the reputation calculations is the legitimacy of the data generated by users of the system. A number of algorithms will monitor usage to detect, prevent and punish manipulation of reputation scores. Analysis of ratings submitted for internal networks (users closely connected to each other by one or more measures like but not limited to recommendations, communication frequency, shared links, etc.) versus external networks (infrequently related users) informs the objectivity factor. Thus, if friends attempt to game the system by voting each other's submissions highly, their objectivity ratings will decrease, reducing their reputation. Thus, reputation includes components that act as a system of checks and balances to ensure the integrity of the rating. FIG. 3 is a generic representation of information flows for reputation development and fraud detection.

A number of manipulation methods exist that must be managed to preserve the validity of the reputation scores. Some of the more common manipulation techniques include but are not limited to: reciprocal voting, sequential chain voting, friend gangs, prejudicial voting (against a person or subject matter), retaliatory voting, and undifferentiated voting. Each of these will be explained with a correction mechanism. In one embodiment, generally, the relational database(s) that capture, store, sort, and retrieve the information on user activity will contain one or more tables that manage information relevant to manipulation prevention. For example, the database(s) will contain tables structured in part to record: unique user identities, unique forum identities, rating values, unique identity of the rating user, date and time of the rating, date and time of user login to the system, time spent reviewing rated content and content features such as but not limited to word length and playback time.

Reciprocal voting occurs when one user rates a second user positively in order to induce the second user to rate the first user positively. A number of methods may detect this manipulation. In the case where the users are the same physical person registered twice in order to vote on themselves, security features such as uniquely identifying information, like but not limited to credit cards or government issued identification numbers, may be required to establish user accounts. In the case where unique information is not required to create user identities or where the users are two different people, voting temporal proximity is one method of manipulation detection. If a first user votes positively for a second user and the second user votes positively for the first user in a short amount of online time (as measured by the time logged on the system since the first user's vote), a database query will send the online time amount to a conditional statement comparing the time to second rating with a threshold. If a threshold condition is satisfied, the first and second user ratings will be flagged as a manipulation. The votes may then be eliminated from the reputation calculation and/or each user's objectivity, integrity or other reputation factor may be reduced by a penalty amount. Thus, manipulative users will cause their reputation to decline. This mechanism may be combined with other corroborative analysis such as but not limited to: reading speed calculated from word count, the time from content loading to vote and compared to the distribution of human reading speeds; image viewing time until voting compared to a threshold; stage of completion for video, audio or multimedia playback prior to voting; deviation from user's sample scores or consistency of voting between the two users.

Sequential chain voting occurs when a variable number of users vote for each other in turn such that no immediate reciprocity exists. Detection of this manipulation requires analysis of the voting records of users in the chain. In one implementation, this begins with a query of all the votes made by user two when they vote on user one. A query is made of all the votes cast by each user identified in the query of user two's records—this is the second level of investigation. Additional levels of investigation occur until a threshold is reached. The threshold being set in a number of ways, for example but not limited to arbitrary designation or experimentation to detect sequential chain lengths. If user one's voting record indicates they voted on another user identified in the investigation levels, then a trail is discovered comprising the users and voting records that link the first user to the second user. Alternatively, if the first user is not connected to the second user when the threshold level of investigation is reached, the collective voting record of the group of users identified in the investigations may be compared to the statistical distribution of users not in the group but voting on the same or similar items. Deviation of voting patterns of the group from the population may indicate manipulation over time. Trails may be stored in database(s) to be used as corroborative evidence should a group with similar users produce suspect voting results in the future. Corrective action on votes and lowering reputation scores would be taken upon manipulation detection.

Friend gangs occur when a group of users with close relationships votes in a concerted manner (positively or negatively) on a non-related user. In one embodiment, the friend gang is detected by evaluating either the frequency of connections (for example but not limited to communications, shared links, votes, etc.) with each other in the group against the frequency of connections from users in the group to users not in the group or by deviation from the average external user (i.e. not in the group) vote. Manipulation occurs when the gang votes uniformly (or with low standard deviation) on a user not in the gang. Thus, if a user receives a certain number of consistent votes within a certain period of time, the users making those votes qualify for a gang manipulation analysis. Consistent voting and gang detection would initiate corrective action on the votes cast and the gang members' reputations.

Prejudicial voting occurs when a user votes consistently and significantly different from a defined benchmark (such as but not limited to the mean, median or mode of a population) for another user or subject matter. For example, a user consistently votes down blue users and/or votes up red users. In one embodiment, this bias is detected by querying the historical voting record of the suspect user, segmenting the information by vote recipients, and performing comparative data analysis, such as but not limited to statistical analysis, within and among relevant segments. Negative reputation effects and voting remediation would follow manipulation confirmation.

Retaliatory voting occurs when user one votes negatively on user two who in turn votes negatively on user one because of the negative vote received. In one embodiment, this manipulation is detected by querying the voting record of user one to determine if a negative vote was cast on user two and a negative vote was received from user two within a threshold of online time, as defined earlier. Corrective action would be taken to eliminate the retaliatory vote impact and reduce the reputation of the retaliatory voter.

Undifferentiated voting occurs when a user votes too consistently. For example, they give a majority of users and content the same rating or a random rating. One embodiment of the manipulation detection queries a user's historical voting record and performs data analysis, such as but not limited to statistics. If the voter had a low standard deviation of vote values, or alternatively if the distribution of their votes matched a random distribution, the user would be considered an undifferentiated voter. Their reputation score would be negatively adjusted as a consequence.

In one embodiment, reputation requires maintenance and considers user history. If a user doesn't contribute to the network, with content and/or voting, for a certain period of time, the user's reputation factors will age and decline in value. Ratings of users with higher reputations, past success, or greater predictive power will carry more weight than less highly rated users. A user will be required to periodically rate users with lower reputation scores in order to maintain scores in the user's citizenship factor, another reputation component. Thus, users have incentives to participate beyond gaining progressive capabilities in the network hierarchy.

In one embodiment, a user will be able to sort communications and content from other users by preference profiles that the user sets and/or by using automated network analysis algorithms. For example, a user may specify that they are most interested in communications about art. The user completes a form indicating these preferences. Data from the form is transferred to a database. When a message is sent to the user, the database is queried and the user's specifications are compared to the message's or content's specifications. The message's or content's specifications include the multi-factor reputation of the sender and descriptors. The descriptors may be specified explicitly by the sender. The message is sorted in the receiving user's queue by whether the message is related to art and whether the sender has a good reputation and/or good art related reputation factors, such as creativity. Thus, a multi-factor reputation enables multi-dimensional differentiation of communication and content senders and receivers. Another embodiment creates a user profile for the sender and receiver automatically, for example (but not limited to) by querying a database for the forum types that the user visits, sorting the forums by frequency, and using the cardinal or ordinal ranking to sort communications and content. Another embodiment enables a sender to filter and sort potential recipients in the same manner, e.g. by explicit or calculated profile and multi-factor reputation.

In one embodiment, in addition to communication management, users will be able to express privacy preferences to prevent disclosure and searches of personal information and actions. Limiting searchable information will limit sorting effectiveness, but this is a user choice.

In one embodiment, additional network algorithms include relatedness and robustness. A network algorithm(s) will use quantitative data and convert qualitative data to quantitative form to determine relatedness between users. Tools used in these algorithms range from statistics to artificial intelligence.

An example of quantitative data uses for relatedness involves restaurant recommendations. When a user seeks a restaurant recommendation, the network will enable the user to sort recommendations from other users based upon how similar their historical recommendations were to the searching user's historical recommendations. In one embodiment, a query retrieves records of users who have made recommendations on a certain number of restaurants, for example 50%, that were also recommended by the user seeking advice. The user(s) with the highest correlations of recommendations on the same restaurants as the advice seeker is the most related user(s). Another query retrieves the restaurant recommendations of the related user(s) that have not also been recommend by the advice seeker. In another embodiment, the user restaurant recommendations are sorted by user reputation and/or reputation factor, such as (but not limited to) the trendsetter factor.

An embodiment of qualitative data converted to quantitative data for relatedness analysis is the conversion of biographical data, e.g. resumes, into numerical values along a vector or array. A user with a liberal arts education receives a 0, a user with a technical/engineering education receives a 2, and a user with an undergraduate technical education and an MBA receives a 1 because the MBA brings the technical education closer to the liberal arts side. The delta between user scores is used to calculate relatedness between the two users. Any qualitative biographical or other type of data point may be converted to a numerical range in this manner, e.g. gender, national origin, political affiliation, education level, experience, personal interests, etc. A user may then sort communication based upon user relatedness. Population segmentation may be conducted in this manner to improve both user communication filtering and market research.

In another embodiment, relatedness is used to generate a persuasiveness reputation value. If two or more users are in a debate forum being judged by an audience of users (in person and/or virtual), the user voted winner of the debate may increase their persuasiveness factor by receiving votes from other users with low relatedness. This is analogous to a liberal convincing a conservative that their argument is better. A query would retrieve the relatedness values from a database of the voters in the debate. A certain number of points per debate would be split between the debating users based upon the percentage of votes received. The user(s) who garnered more votes from unrelated voters would have their share of points increased by a weighting factor proportional to the number of unrelated voters the user persuaded. The points would be allocated by this methodology first to the winner, then to the user with the second highest number of votes, then to the user with the third highest number of votes, and so on until the debating users had received an allocation. If the number of debate points ran out before each debating user received their allocation, those user(s) would have points subtracted from their persuasiveness factor in an amount equal to the number of points they would have added if there existed enough debate points. In this manner, users receiving more votes and convincing voters dissimilar to themselves are disproportionately rewarded. One skilled in the art will note that many possible allocation techniques exist using relatedness.

In one embodiment, robustness between users analyzes the frequency, duration, importance, and longevity of relationships. Thus, people that users communicate with frequently, at greater length, with higher content quality ratings, over extended periods will be deemed more robust relationships than people with whom users speak to rarely and briefly with low ratings. Robustness is example of another reputation factor, among many, that may be used in a multidimensional manipulation of communications or content. Note that robustness, like relatedness, is a type of reputation factor characterizing the dynamics between two users or items in contrast to other types of reputation factors that characterize a single user.

This social network analysis and management system will be applied to all communication channels, including but not limited to: Internet, intranets, wireless communications, message boards, chat rooms, instant messaging, e-mail, voice, audio, multimedia, and static displays in community forums or personal forums, e.g. personal pages/profiles.

The factors presented are merely examples to illustrate platform functionality. The range of factors and algorithms used is very large and will include default factors and user suggested factors.

1. A method to create and modify a user's reputation in a network, the method comprising: data collection from direct input by the user and other users, the user's behavior, other users' behavior and data external to the users; processing the data to create values for one or more component reputation factors; and combining the values of multiple reputation factors into a global and/or local reputation value.

2. The method of claim 1 where multiple numerical reputation factors may be combined into a global or local reputation value using a variety of mathematical formulae.

3. The method of claim 2 where data is collected, stored, manipulated and retrieved electronically.

4. The method of claim 3 where reputation factors may be standardized globally, standardized locally, and/or defined by users.

5. The method of claim 4 where one or more reputation factors are derived from one or more other reputation factors.

6. The method of claim 5 where data analysis changes one or more reputation factors in the multi-factor reputation.

7. The method of claim 6 where data and/or reputation factor rank a user by percentile of the total network population.

8. Method to detect user manipulation of their reputation or other user's reputation and manage the fraud or manipulation, the method comprising: the occurrence of a triggering event, data analysis of one or more users' behavior and stored information and preventing manipulation and/or creating consequences for the manipulating user(s).

9. The method of claim 8 where the triggering event is a time interval, threshold, user action, manual intervention or a combination of these.

10. The method of claim 9 where data analysis changes one or more reputation factors in a user's multi-factor reputation.

11. The method of claim 10, where data and/or manipulation factor(s) rank a user by percentile of the total network population.

12. A system comprising: one or more users communicating and/or using information on one or more computers and/or electronic networks; global and/or local multi-factor user reputations for each user; and hierarchies organizing users into progressively more restrictive network levels based upon user multi-factor reputations.

13. A system of claim 12 where the communication is one to one, one to many or many to many via digital or digital to analog computers and/or networks.

14. A system of claim 13 that gradates by hierarchies the functionality of searching, filtering, sorting, ordering, screening, compiling, grouping, deleting, flagging, hiding, highlighting, promoting, modifying and any combination of these capabilities.

15. A system of claim 14 where system structures are designed to inform reputation factors.

16. A system of claim 15 where the information includes administrator and/or user generated: intranet sites, Internet sites, World Wide Web sites, electronic mail or email, interactive electronic bulletin boards, interactive electronic message boards, online information exchanges, video, audio, text messages, images, news groups, chat rooms, software, synchronous communications, asynchronous communications and data.

17. A system of claim 16 where positive and negative incentives encourage user participation in addition to the progressive management capabilities of the user hierarchy.

18. The system of claim 13 wherein the computers are in a peer computer system.

19. The system of claim 13 wherein the computers are in a server computer system that aggregates reputations of a user.

20. A method of communication and information management, the method comprising: tagging a communication or information with attributes that include: content descriptors; sending the communication or information to a recipient; algorithms that process the communications or information using the tagged information.

21. The method of claim 20 where the attributes include the creator's multi-factor reputation value and the sender's multi-factor reputation value.

22. The method of claim 21 where the processing algorithm also uses the recipient's behavior patterns and multi-factor reputation.

23. The method of claim 22 where the sender and/or the recipient create a preference profile that may be used to tag information in the sender's case or process communications and information in the recipient's case.

24. The method of claim 23 where the recipient manipulates communications or content by searching, ordering, screening, compiling, grouping, deleting, flagging, hiding, highlighting, promoting, modifying and any combination of these capabilities using preferences.

25. A method of converting qualitative information sets into quantitative information, the method comprising: two or more pieces of qualitative information or user behavior patterns, assigning numerical values to each piece of information or behavior pattern, the degree of difference in the numbers assigned being dictated by the similarity or dissimilarity of the information pieces or behavior patterns.

26. The method of claim 25 where the conversion mechanism is based upon user behavior and/or characteristics.

27. The method of claim 26 where numerical weights are combined with the number describing the qualitative information to reflect the strength of the association between the user and qualitative information.

28. A method of converting qualitative information into quantitative information, the method comprising: one or more characteristics or behaviors of a user and either rules or calculations that translate qualitative information to quantitative form.

29. A method of prediction using user reputation and reputation factors, the method comprising: a user rating of a target (target being a living being, entity, object, action, event, outcome, algorithm or information); a measure of success for the rating target; collecting the ratings and target success values over time; and performing data analysis of the ratings and success measures to generate values for a global and/or local derivative reputation factor.

30. The method of claim 29 where target characteristics, other reputation factors, user behavior and user characteristics are included in the prediction algorithm.

31. A method of selecting something to present to a user based upon multi-factor reputations, the method comprising: a population of users with multi-factor reputations, a presentation target (target being an advertisement; text, image, audio, video or multi-media object), performing data analysis to determine which user(s) are likely to achieve the desired outcome of presenting the target given their multi-factor reputation and/or reputation factors, and presenting the target to the identified user(s).

32. A computer-readable medium containing instructions for controlling a computer system to provide communication and information management, by a method comprising: the creation and manipulation of multi-factor reputations for a user or users, the control of communications and information to and between users based upon multi-factor reputations and user preferences.

33. The computer-readable medium of claim 32 where: the multi-factor reputations are adjusted to account for user manipulation attempts, qualitative information is converted into quantitative information, predictions are generated and targeted presentations of things are made from reputations and user information.

34. A computer system for processing communications and information based upon a multi-factor reputation, comprising: a hierarchical electronic network with progressive communication and information management capabilities defined by multi-factor reputations and utilizing a variety of content types and venues.

35. A business method for operating a multi-factor reputation-based communication or content provision service, the business method comprising: multi-factor reputation and manipulation management, qualitative information conversion, prediction capabilities, reputation communication and verification, and targeted presentation of items to users.

36. A business method as in claim 35, wherein the remuneration is a financial remuneration, a product remuneration, a service remuneration, a commission remuneration, a referral remuneration, or any combination of the prior.
